(19) United States
(12) Patent Application Publication
(10) Pub. No.: US 2007/0174224 A1
(43) Pub. Date: Jul. 26, 2007

(54) SCRIPTABLE INFERENCE NETWORKS FOR SENSOR INFORMATION FUSION

(76) Inventors: DAVID C. SWANSON, State College, PA (US); RICHARD CURTIS, Port Matilda, PA (US); GERRY KASMALA, State College, PA (US)

Correspondence Address: MCKEE, VOORHEES & SEASE, P.L.C.;ATTN: PENNSYLVANIA STATE UNIVERSITY, 801 GRAND AVENUE, SUITE 3200, DES MOINES, IA, 50309-2721, US

(21) Appl. No.: 11/535,521

(22) Filed: Sep. 27, 2006

Related U.S. Application Data
(60) Provisional application No. 60/723,524, filed on Oct. 4, 2005.

(51) Int. Cl. G06N 7/02

(52) U.S. Cl. 706/52

(57) ABSTRACT

A system for breaking down complex problems and evaluating by common continuous inference network (CINET) agents, includes a hierarchical script and a plurality of relational electronic documents wherein each electronic document includes: (a) a plurality of information input elements comprising data and confidences; (b) a fuzzy logic transfer function element; and (c) an output element.

### CROSS-REFERENCE TO RELATED APPLICATION

This application claims priority to U.S. Provisional Patent Application No. 60/723,524, filed Oct. 4, 2005, herein incorporated by reference in its entirety.

### GRANT REFERENCE

Work related to the invention disclosed in this application was performed under U.S. Marine Corps., Contract No. M67004-99-D-0037/MU-60. The government may have certain rights in this invention.

### BACKGROUND OF THE INVENTION

A Continuous Inference Network (CINET) is a technique for fusion of information in computing software. It allows continuous blending of information with varying confidences using fuzzy logic. This logic follows human expertise in that combinations of various information inputs may have unique logic applied relative to the situation, or context of the recognition decision. While this allows computing with a boundless complexity of logic, generation of executable software, even if automated, results in an inefficient bottleneck due to centralized compiling, testing, and evaluation. One example of a CINET is described in U.S. Pat. No. 5,642,467 to Stover et al, herein incorporated by reference in its entirety, which discloses a controller for directing the actions of an autonomous device in response to the existence or actions of objects using a program for fusing physical world data and inferred property confidence factors into representational instances.

Algorithms for pattern recognition generally require ether an explicit mathematical model, or a measurement technique where one compares a statistical pattern from training data to the unknown data of interest to find a “best fit” to the existing training data. With this approach, there is always uncertainty about how the recognition algorithm will perform when unique data is presented. Using Continuous Inference Networks (CINETs), one still has the flexibility of using traditional pattern recognition as part of a transfer function between sensor or other input signals, and a recognition output. However, one can then logically combine inputs and outputs using fuzzy logic transfer functions in CINETs to extend recognition and control to highly complex and nonlinear situations with predictable output results. This allows experts in a given field to prescribe different recognition models (perceptor models) for different inputs and situations while also prescribing different responses (affector models), again depending on the logical situation. While this is seen as a breakthrough in artificial intelligence, the CINETs can get very large and complex, making application to very complex problems difficult.

Thus, although CINETs are advantageous, problems remain.

### BRIEF SUMMARY OF THE INVENTION

Therefore, it is a primary object, feature, or advantage of the present invention to improve over the state of the art.

It is a further object, feature, or advantage of the present invention to provide method of solving problems that allows different recognition models to be used for different inputs and situations while also prescribing different responses depending upon the logical situation.

Another object, feature, or advantage of the present invention is to simplify the process of applying CINETs to complex problems.

Yet another object, feature, or advantage of the present invention is to use CINETs in a manner that avoids inefficient bottlenecks due to centralized compiling, testing, and evaluation.

It is a further object, feature, or advantage of the present invention is to use a hierarchy of relational documents to break down complex problems for evaluation by CINET agents.

A still further object, feature, or advantage of the present invention is to provide a method of processing very complex problems, including problems such as situational awareness, human response advisement, and/or automated control response.

Yet another object, feature, or advantage of the present invention is to provide a method of using CINETs that simplifies human understanding and interaction with CINETs.

A further object, feature, or advantage of the present invention is to provide a method of using CINETs that separates program elements from CINET logic.

One or more of these and/or other objects, features, or advantages of the present invention will become apparent from the specification and claims that follow.

According to one aspect of the present invention, a system is provided for breaking down complex problems and evaluating the problems by common continuous inference network agents. A hierarchical script is used to design a set of relational electronic documents. Each electronic document includes information input elements providing data and confidence levels, a fuzzy logic transfer function element, and an output element. The documents may also include a blend transfer function to map the output element onto a normalized scale. Preferably each of the electronic documents is a document which uses tags, such as an XML document and there is a hierarchical relationship between the electronic documents.

According to another aspect of the present invention, a method for using a hierarchy of relational electronic documents in a continuous inference network is provided. The method includes providing a plurality of relational electronic documents where each of the documents includes (a) at least one input element comprising data value, a confidence value, and a scale value; (b) a fuzzy logic transfer function element; and (c) an output element. The method further includes processing each of the plurality of relational electronic documents to provide a logical inference and outputting the logical inference.

Using a hierarchical script to design a fuzzy logic pattern recognition algorithm allows for generic common runtime software on smart sensors and agents as well as common development and testing tools by converting the CINET program into a hierarchy of relational documents. The purpose of this information processing architecture is to break down complex problems in pattern recognition and control into small fuzzy logic-based scripts that can be evaluated by common CINET agents (network operable programs). Large numbers of identical agents, each with unique document scripts to follow, can collaboratively process very complex problems is automation of situational awareness, human response advisement, and/or automated control response.

According to another aspect of the present invention, a system for breaking down complex problems and evaluating by common continuous inference networks is provided. The system includes a hierarchical script and a plurality of relational electronic documents where each of the documents includes (a) at least one input element having data and confidences, (b) a fuzzy logic transfer function element, and (c) an output element. The system further includes at least one data collection devices referenced by at least one input element and a physical device for producing an output based on one of the output elements.

### BRIEF DESCRIPTION OF THE DRAWINGS

FIG. 1 is a block diagram of a document having a number of inputs.

FIG. 2 is a diagram of a hierarchal structure which implements a CINET.

FIG. 3 is a block diagram of one embodiment of methodology.

FIG. 4 is a representation of a screen display for designing a hierarchal structure which implements a CINET.

FIG. 5 is a diagram of a CINET.

### DETAILED DESCRIPTION OF THE PREFERRED EMBODIMENT

This invention implements the CINET using a hierarchical structure of documents, where each document represents a number of information inputs (data plus confidences), a fuzzy logic transfer function (fuzzy AND, OR, XOR, etc., and a blend transfer function to map the output onto a normalized scale. This CINET node output can in turn be referenced as one of the inputs in another document, and so on. Each document represents a logical inference, or question to be answered based on the available input information, the answer expressed as a confidence measure, say on a normalized headed scale of zero to one. By design, the CINET document scripts, or CINDOCS, are kept as simple as possible so that the output confidence is if the result of a clear relationship between the inputs and output such as a relationship based on the scientific method or explicit rules. The CINDOCS is therefore a document readable by people with expertise in the underlying logic, rather than the computer sciences.

The actual executable software that implements the CINET using CINDOCS is now a common program element completely independent of the CINET logic, which may contain proprietary or even encrypted information. Using a multitasking architecture, each CINDOCS is associated with a generic CINET process instance. The fact that a large hierarchy CINDOCS may involve a significant number of CINET processes is not of concern, because the processing overhead is quite small. However, this architecture is well suited for parallel computing as well as computing across large networks of separate computers, each with access to different information. When a CINET process is accessing information from across the network, we will refer to the CINET process as a CINET agent. Since each CINET program is identical whether it is operating as a local process or a networked agent, a common CINDOCS reader program can launch a number of CINET processes or agents as required by the CINDOCS. The commonality of the CINDOCS reader and the CINET programs offer the user an infinite amount of programming flexibility with ever having to compile a specific CINET implementation. However, the structure of the CINDOCS must also be flexible, machine readable, human readable, yet structured enough to allow a common persistent form.

Extensible markup language, or XML, is the preferred embodiment of the CINDOCS. It is readable by humans and computers, has a nested structure, and can have elements linking the current XML document to other XML documents. We require this last feature in order to tie a hierarchy of CINDOCS together, although XML is not normally used in this way. XML is a tagged-element database where one can establish a customized hierarchy of tags to describe information of all kinds. In our invention, we exploit XML to implement fuzzy logic using a pair of generic programs; the CINET process or agent and the CINDOCS reader. All of the human intellect and creativity related to the problem that the CINET is solving is contained in the CINDOCS as text document readable by humans and computers, where XML is the preferred embodiment.

The CINDOCS can either be simply typed following the nested structure, or generated by a graphical program called the CINDOCGUI. The CINDOCGUI can be used to read the CINDOCS and produce a logical graph of the information fusion logic and blending in the document. Also, the CINDOCGUI can be used to generate a CINDOCS where the user can assemble the logical connections between the CINET inputs, the logical transfer functions, and the output blending function. The graphical representation of the CINDOCS is a very convenient and useful way to give access to the CINET by those domain experts unskilled in the computer sciences.

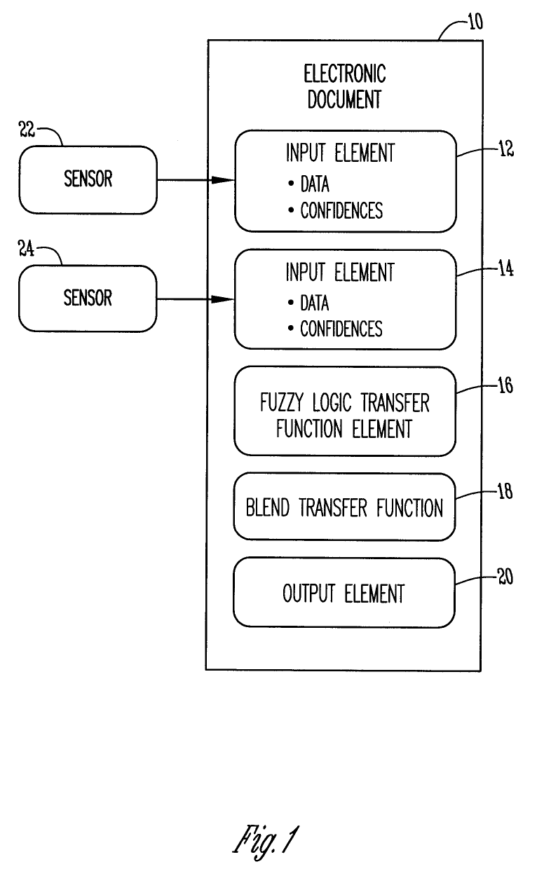

FIG. 1 is a block diagram of an electronic document 10 having a number of inputs. The electronic document 10 includes a first input element 12 which includes data and confidences. There is also a second input element 14 which also includes data and confidences. The electronic document 10 further includes a fuzzy logic transfer function element 16. The electronic document 10 also includes a blend transfer function 18 and an output element 20. The first input element 12 is linked to a sensor 22. The second input element 14 is linked to a sensor 24. The present invention uses documents such as, but not limited to, the electronic document 10 arranged in relational manner to form a CINET.

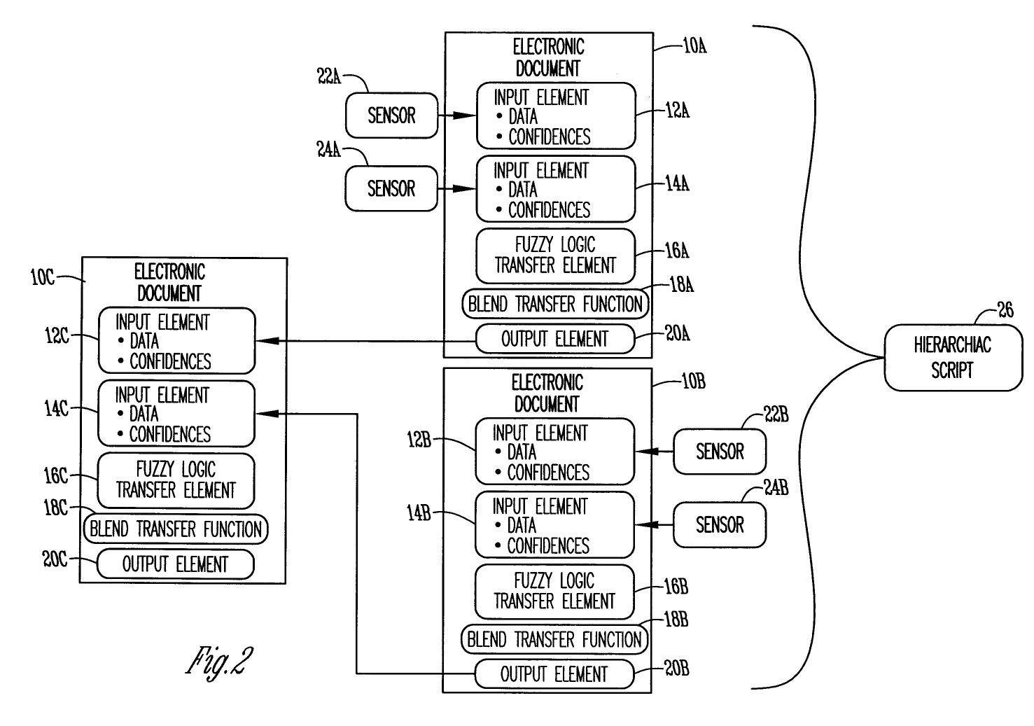

FIG. 2 is a diagram of a hierarchal structure which implements a CINET. As shown in FIG. 2, there is an electronic document 10A with input elements 12A, input element 14A, fuzzy logic transfer element 16A, blend transfer function 18A, and output element 20A. Similarly, there is an electronic document 10B with input element 12B, input element 14B fuzzy logic transfer element 16B, blend transfer function 18B, and output element 20B. Also, there is an electronic document 10C with input element 12C, input element 14C, fuzzy logic transfer element 16C, blend transfer function 18C, and output element 20C. The electronic document 10A uses sensor 22A as the first input element 12A. The electronic document 10A uses a sensor 24A as a second input element. Similarly, the electronic document 10B uses a sensor 22B as a first input element 12B and a second sensor 24B as input to a second input element 14B. The electronic document 10C uses as inputs element 12C the output element 20A from electronic document 10A. The electronic document 10C uses as an input element 14C, the output element 20B of the electronic document 10B. Thus, it can be clearly shown that a hierarchal structure is formed which can include any number of electronic documents, each with any number of input elements. The documents are linked together in a hierarchal fashion. A hierarchal script 26 can be used to create this hierarchal structure and/or the electronic documents within a hierarchal structure.

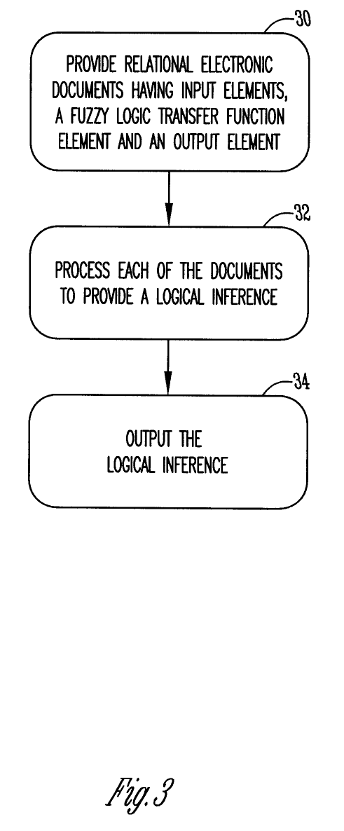

FIG. 3 illustrates one embodiment of a methodology of the present invention. In step 30, relational electronic documents are provided. The relational electronic documents have input elements, fuzzy logic transfer function element, and output element. In step 32, each of the documents are processed to provide a logical inference. In step 34, the logical inference is output.

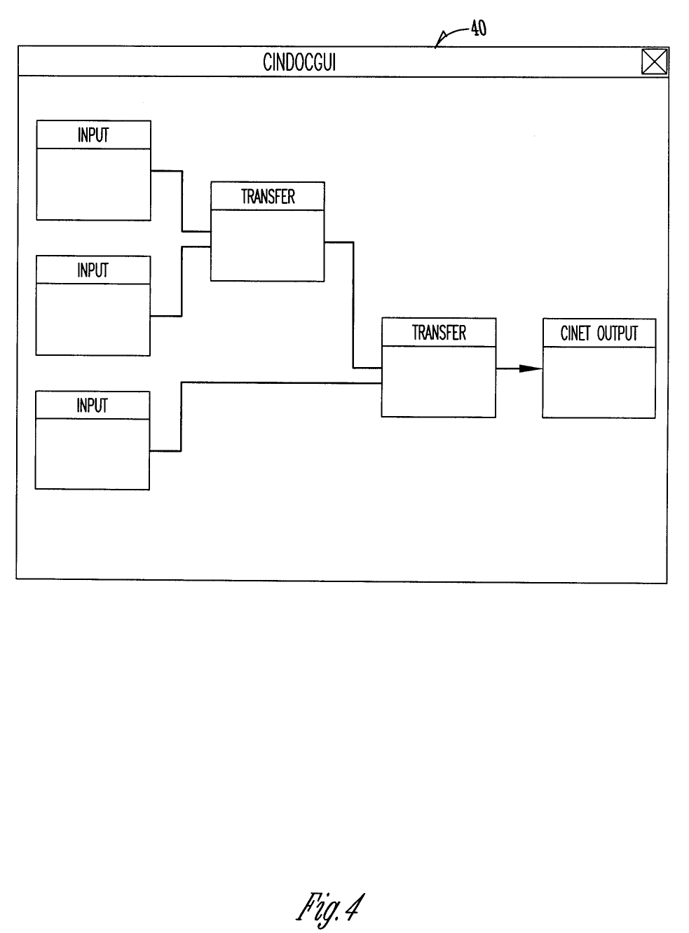

FIG. 4 illustrates one embodiment of a screen display for a graphical user interface for creating the hierarchal structure. The graphical user interface allows a user to add input elements, transfer functions and create logical relationships between these elements and functions in order to provide outputs including an overall CINET output. Thus, a user may design the CINDOCS for a particular CINET in this manner. Also, the present invention contemplates that source code, such as HTML or XML source code may be read by the graphical user interface to thereby create the screen display 40 shown.

One use of a CINET is for use with sensor in the context of detection of chemical weapons. For example, consider 3 chemical vapor sensors capable of detecting mustard gas. For a particular concentration, sensor “A” detects with 80% confidence and reports a 6 on a 1 to 10 scale. Sensor “B” detects with 90% confidence and reports a 3 on a 1 to 3 scale (hi, medium, low). Sensor “C” detects with a 70% confidence and reports a 1, on a 0 to 1 scale (a simple yes or no to the agent's presence). A typical CINET design might initially normalize all 3 sensor to a 0 to 1 scale (report would be 0.6, 1.0, and 1.0, respectively). Experiments with interfering chemicals, sensor expertise, and the scientific method determine that the best overall blending of the sensors is to use a 60% weighting on sensor “B” and a logical AND with either sensor “A” OR sensor “C”, each with a 20% weighting. The CINDOCS in XML would be:

<?xml version=“1.0”?>
<cinet>

<chemical>mustard</chemical>
<input>

<name>A</name>
<confidence>0.80</confidence>
<level>6</level>
<scale>10</scale>

</input>
<input>

<name>B</name>
<confidence>0.80</confidence>
<level>3</level>
<scale>3</scale>

</input>
<input>

<name>C</name>
<confidence>0.70</confidence>
<level>1</level>
<scale>1</scale>

</input>
<transfer>

<type>OR</type>
<input>

<name>A</name>
<weight>0.20</weight>

</input>
<input>

<name>C</name>
<weight>0.20</weight>

</input>
<outputname>ORout</outputname>

</transfer>
<transfer>

<type>AND</type>
<input>

<name>B</name>
<weight>0.60</weight>

</input>
<input>

<name>ORout</name>
<weight>1.0</weight>

</input>
<outputname>ANDout</outputname>

</transfer>
<cinetoutput>ANDout</cinetoutput>

</cinet>

One can see the three inputs in the XML document, the two logical transfer functions, and the output information. When designing the CINDOCS, the user gives each input and output a unique name, and for the inputs, a way to find the input information (a file name and path, hardware port number, IP address and port number, etc.). An efficient way for the CINDOCS to structure its information is for the input elements to point to XML documents. If each sensor's software driver fills out an appropriate XML document in a file system, it makes it a straightforward manner to “wire” the CINET using a tool like the CINDOCGUI such that the inputs refer to elements in the appropriate XML documents. This also makes it transparent whether the CINDOCS input is from a sensor or another CINDOCS output element, allowing a hierarchical structure of CINDOCS executed by generic CINET and CINDOCS reader programs.

Availability of a CINDOCS hierarchy allows very complex sensor interactions to be captured and fused logically according to well-understood scientific principles. For example, if the performance of sensor “B” in the above example degrades in cold temperatures, a temperature sensor input in a CINET for sensor “B” could be used to reduce the confidence in the cold. This in turn would signal other CINET processes to adjust their respective weights accordingly. The performance characterization of the sensor need not know how the information is being used. But, the designer of the CIDOCS in the above example might include additional logic to deal with sensor “B” in the cold, gracefully eliminating sensor “B” once its information is unreliable.

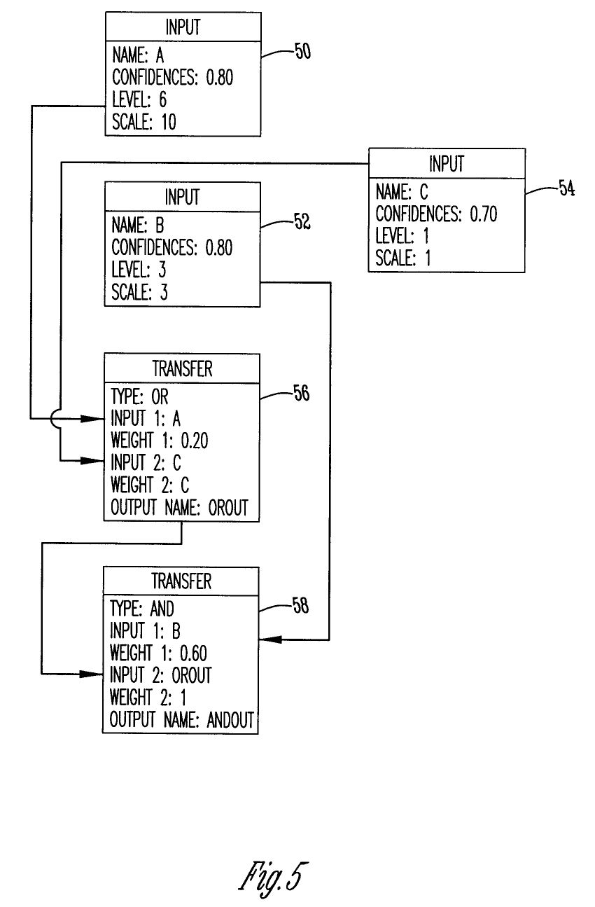

FIG. 5 provides a representation of the CINDOCS hierarchy for the above described example. An input element 50 is shown corresponding with sensor A. An input element 52 is shown corresponding with sensor B. An input element 54 is shown corresponding with sensor C. A transfer function 56 is shown which has as input the information from input element 50 and information from input element 54. A transfer function element 58 is shown which uses as input information from the transfer element 56 and information from input element 54.

The processes begin at the lowest independent levels, such as at the sensors. When this baseline information is available, the dependent CINET process for each CINDOCS can use this sensor information to answer its respective inference, thus making this information to other CINETS if needed, and ultimately to people. If key information is not available for a given CINET, its CINDOCS gracefully shows a lack of evidence to support the inference. This is different than a CINET showing strong evidence that the inference is false or absent.

The CINET breakthrough in fuzzy logic perception and control is further extended in this invention by breaking the overall CINET into minimal-sized logical inferences and representing this “mini CINETs” in the form of a document. Large CINETs are then implemented using a large number of identical “agent” programs, each one following the information in the script. Building the CINET in this way not only simplifies the human understanding of the script, but it also allows for widely distributed networked systems to collaboratively produce predictable results on large complex information problems. For example, the “mini-CINETs have multiple signal inputs and a single output in the form of recognition, of their particular inference as a varying signal from false (O) to true (1). This can be thought of as a “virtual sensor” and we can represent the information of the output in a section of the CINET script document. As such, a limitless combination of sensors and mini-CINETs, each with their corresponding scripts, can be used by generic agents to recognize complex situations and map the corresponding actions or advisements required.

In recent years, software tools for the Internet have produced document formats such as XML that permit a wide range of data to be tagged and databased in a way that can be displayed for humans as well as read by machines. Using XML as the format for our CINET scripts, sensor information, and CINET outputs, allows the use of well developed tools for the Internet to be applied to the situational awareness and control problem. This is of particular use when the problem is physically distributed, much data is processed locally into salient information, and the dynamics of the situation may require changes in the CINET script documents on the fly or the addition of more years of CINETs for detect and control a particular situation. The document-based CINET approach also supports off-one analysis and debugging for logic flaws as well as identification of logic “holes” that must be addressed by the scientific method to produce the mussing scripts. This approach also allows collaborative interaction between the various CINETs for what is known a “Swarm Intelligence” [J. Kennedy and R. Eberhart, Swarm Intelligence, Academic Press, 2001], herein incorporated by reference in its entirety.

It should be understood that instead of sensors, the present invention may use any number of types of data collection devices including switches, measurement devices, and other types of devices whether mechanical, electrical, or chemical in nature. In addition, an output is provided by a physical device. The physical device may be a computer with a CINET output displayed on a screen, such as shown in FIG. 4. Alternatively, the physical device may be configured to perform any number of actions in response to a particular output. The present invention contemplates numerous variations.

That which is described is merely exemplary. The present invention contemplates numerous different embodiments, variations, and alternatives. For example, different problems will require different types of input, different sizes of scripts, different blending functions, different logic. These and numerous other variations are all within the broad spirit and scope of the invention.

What is claimed is:

1. A system for breaking down complex problems and evaluating by common continuous inference network agents, comprising:
a hierarchical script;
a plurality of relational electronic documents wherein each electronic document comprises:
(a) a plurality of information input elements comprising data and confidences;
(b) a fuzzy logic transfer function element;
(c) an output element;
wherein the plurality of relational electronic documents are designed by the hierarchical script.

2. The system of claim 1 further comprising a plurality of data collection providing input to the input elements.

3. The system of claim 1 further comprising a physical device adapted to receive an output from the system.

4. The system of claim 1 wherein each of the elements of the electronic document are tagged.

5. The system of claim 1 wherein each of the plurality of electronic documents are XML documents.

6. The system of claim 1 wherein the output element of a first of the plurality of documents comprises a reference to an input element of a second of the plurality of documents.

7. The system of claim 1 wherein each of the plurality of electronic documents further comprises a blend transfer function to map the output element onto a normalized scale.

8. The system of claim 1 wherein each of the plurality of relational electronic documents is associated with a sensor.

9. A method for using a hierarchy of relational electronic documents in a continuous inference network, comprising:
providing a plurality of relational electronic documents comprising:
(a) at least one input element comprising data value, a confidence value, and a scale value;
(b) a fuzzy logic transfer function element;
(c) an output element;
processing each of the plurality of relational electronic documents to provide a logical inference;
outputting the logical inference.

10. The method of claim 9 wherein the step of outputting the logical inference comprises forming an additional electronic document having an output element comprising the logical inference.

11. The method of claim 9 wherein the step of providing includes designing the plurality of documents using a graphical tool.

12. The method of claim 9 wherein the step of outputting includes displaying on a graphical display.

13. The method of claim 9 further comprising designing the plurality of relational electronic documents with a hierarchical script.

14. A system for breaking down complex problems and evaluating by common continuous inference network agents, comprising:
a hierarchical script;
a plurality of relational electronic documents where each electronic document comprises:
(a) a plurality of information input elements, comprising data and confidences,
(b) a fuzzy logic transfer function element,
(c) an output element,
wherein the plurality of relational documents are designed by the hierarchical script;
at least one data collection devices referenced by at least one input element;
a physical device for producing an output based on one of the output elements.

15. The system of claim 14 wherein at least one of the at least one data collection devices is a sensor.

16. The system of claim 1 wherein the sensor is a chemical sensor.

17. The system of claim 14 wherein the physical device is a computer equipped with a display for displaying the output.
